(19) United States
(12) Patent Application Publication
(10) Pub. No.: US 2007/0289181 A1
(43) Pub. Date: Dec. 20, 2007

(54) Room decorating kit

(76) Inventors: Michael P. Martirano, Morristown, NJ (US); Edward Joseph Duenas, Martinsville, NJ (US)

Correspondence Address: MCCARTER & ENGLISH, LLP, FOUR GATEWAY CENTER, 100 MULBERRY STREET, NEWARK, NJ, 07102, US

(21) Appl. No.: 11/384,985

(22) Filed: Mar. 20, 2006

(51) Int. Cl. G09F 7/00

(52) U.S. Cl. 40/584

(57) ABSTRACT

A room decorating kit for decorating a flat surface which includes at least one two-dimensional scenic component applied to the surface and at least one three-dimensional scenic component applied to the surface. The two-dimensional scenic component and the three dimensional scenic component are sized, shaped and positioned so as to provide a continuous and aesthetically pleasing effect. The three dimensional scenic component may be attached to the surface by standard connectors and fasteners. The components of the kit can relate to any desired theme and can be positioned and arranged on the surface in any manner desired.

### FIELD OF THE INVENTION

The present invention relates to a room decorating kit and, more particularly, to a kit for decorating a wall having two-dimensional and three-dimensional elements.

### BACKGROUND OF THE INVENTION

Wall decorations have long been utilized as an integral part of decorating a room and, as such, these decorations embody a variety of colors, textures, reliefs, and scenes to produce a wide variety of decorating styles and effects. Many current wall decorating kits employ two-dimensional components to create scenes or themes for the purpose of evoking impressions when viewed by occupants of the room (for example, wall paintings, framed pictures, and murals). However, these kits do not employ three-dimensional components, either alone or in combination with two-dimensional components, which allow one to create a fluid scene that evokes considerable aesthetic pleasure. In addition, the use of only two-dimensional components to fabricate a scene limits one's flexibility in changing the scene itself. Accordingly, there is a need for a room decorating kit that utilizes two dimensional and three-dimensional components which cooperate to evoke heightened aesthetic pleasure and that can be changed and alternated on a periodic basis as desired.

### SUMMARY OF THE INVENTION

A room decorating kit for decorating a flat surface which includes at least one two-dimensional scenic component applied to the surface and at least one three-dimensional scenic component applied to the surface. The two-dimensional scenic component and the three dimensional scenic component are sized, shaped and positioned so as to provide a continuous and aesthetically pleasing effect. The three dimensional scenic component may be attached to the surface by standard connectors and fasteners, such as VELCRO® brand hook and loop fasteners, screws and anchors, hooks, clasps or adhesives. The components of the kit can relate to any desired theme, such as sports, holidays, seasonal, cartoon figures, astronomy, cars, etc. and can be positioned and arranged on the surface in any manner desired, limited only by the imagination of the user.

Specifically, the present invention has been adapted for use as part of a décor system for residential use. However, the present invention can be utilized to decorate other environments, such as hotels, restaurants, offices, etc. Further features and advantages of the invention will appear more clearly on a reading of the detailed description of an exemplary embodiment of the invention, which is given below by way of example only with reference to the accompanying drawings.

### BRIEF DESCRIPTION OF THE DRAWINGS

For a more complete understanding of the present invention, reference is made to the following detailed description of an exemplary embodiment considered in conjunction with the accompanying drawings, in which:

FIG. 1 is a side elevational view of a wall that includes the components of a room decorating kit constructed in accordance with an exemplary embodiment of the present invention;

FIG. 2 is a partial cross-sectional view, taken along the line II-II and looking in the direction of the arrows, of the wall containing the components of the room decorating kit shown in FIG. 1; and,

FIG. 3 is a partial side elevational view of the wall shown in FIG. 1, including an exploded view of a first multi-dimensional scenic component, constructed in accordance with the present invention.

FIG. 4 is a partial side elevational view of the wall shown in FIG. 1, including an exploded view of a second multi-dimensional scenic component, constructed in accordance with the present invention.

### DETAILED DESCRIPTION OF THE INVENTION

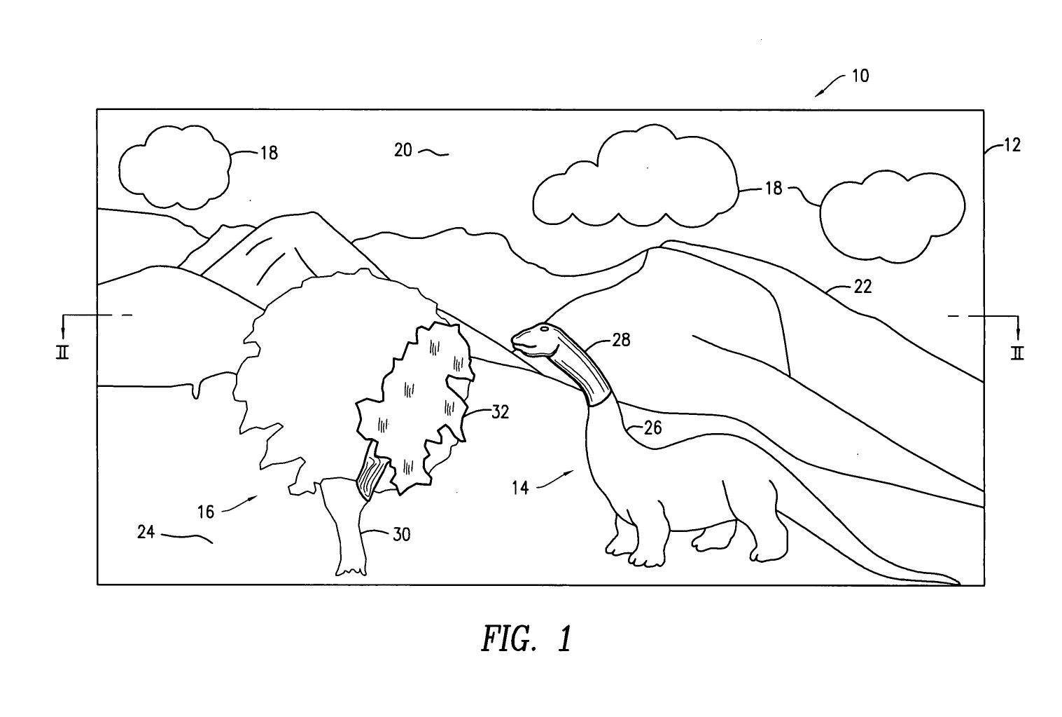

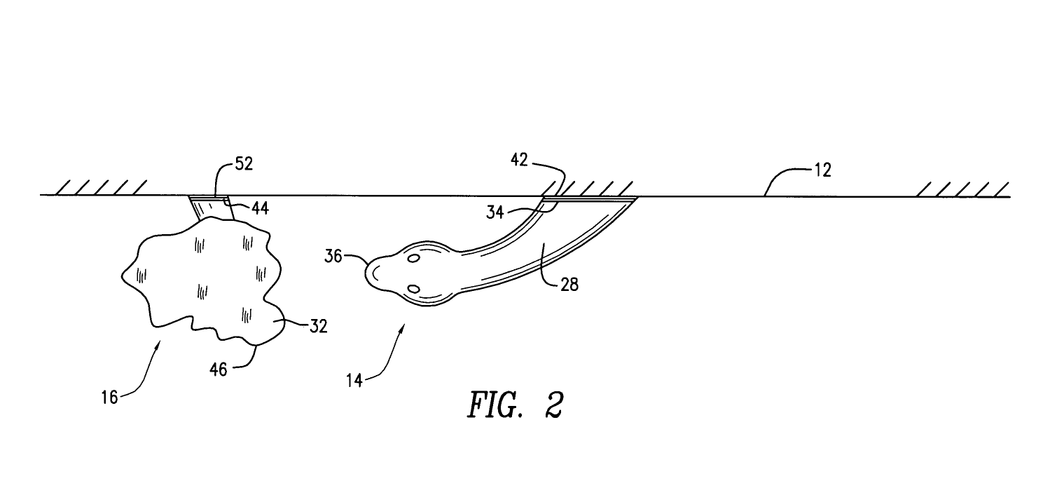

Referring to FIGS. 1 and 2, a room decorating kit 10, which contains elements to be deployed on a flat surface 12, includes multi-dimensional scenic components 14, 16 and two-dimensional background scenic components 18, 20, 22, 24. By way of example, the component 14 is sized and shaped to depict a dinosaur, while the component 16 is sized and shaped to depict a tree (see FIG. 1). Also, by way of example, the components 18 are sized and shaped to depict clouds, the component 20 is sized and shaped to depict a sky, the component 22 is sized and shaped to depict a mountain range, and the component 24 is sized and shaped to depict a grassy plain (see FIG. 1).

Still referring to FIGS. 1 and 2, the component 14 includes a two-dimensional portion 26 adhered to the surface 12 and a three-dimensional portion 28 that extends outwardly from the surface 12. By way of example, the portion 26 is sized and shaped to depict a dinosaur body, while the portion 28 is sized and shaped to depict a corresponding dinosaur head and neck (see FIG. 1). Similarly, the component 16 includes a two-dimensional portion 30 adhered to the surface 12 and a three-dimensional portion 32 that extends outwardly from the surface 12. By way of example, the portion 30 is sized and shaped to depict a tree, while the portion 32 is sized and shaped to depict a corresponding tree branch (see FIG. 1).

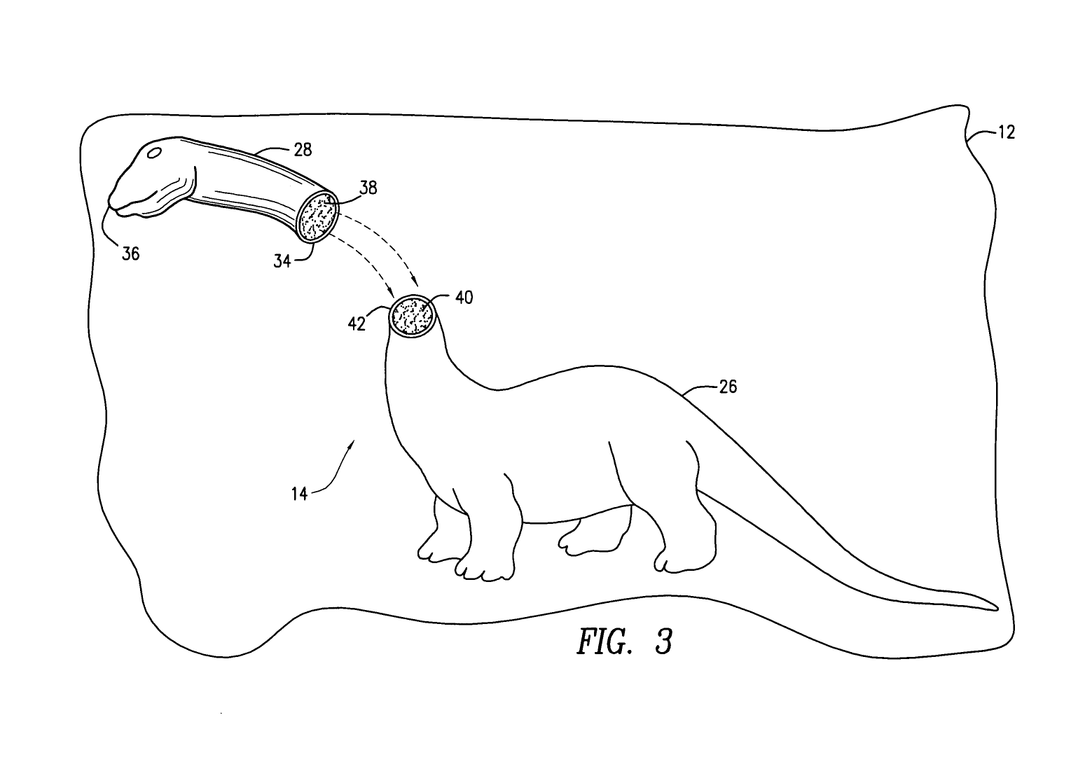

Referring to FIGS. 2 and 3, the portion 28 includes a first end 34 and a second end 36 opposite thereof. A mating element 38 is positioned at the first end 34 of the portion 28, whose function shall be described hereinafter. A corresponding mating element 40 is positioned at a predetermined location 42 of the portion 26, whose function shall be described hereinafter. The first end 34 of the portion 28 is attached to the surface 12 at the location 42 of the portion 26, while the second end 36 of the portion 28 extends outwardly from the surface 12.

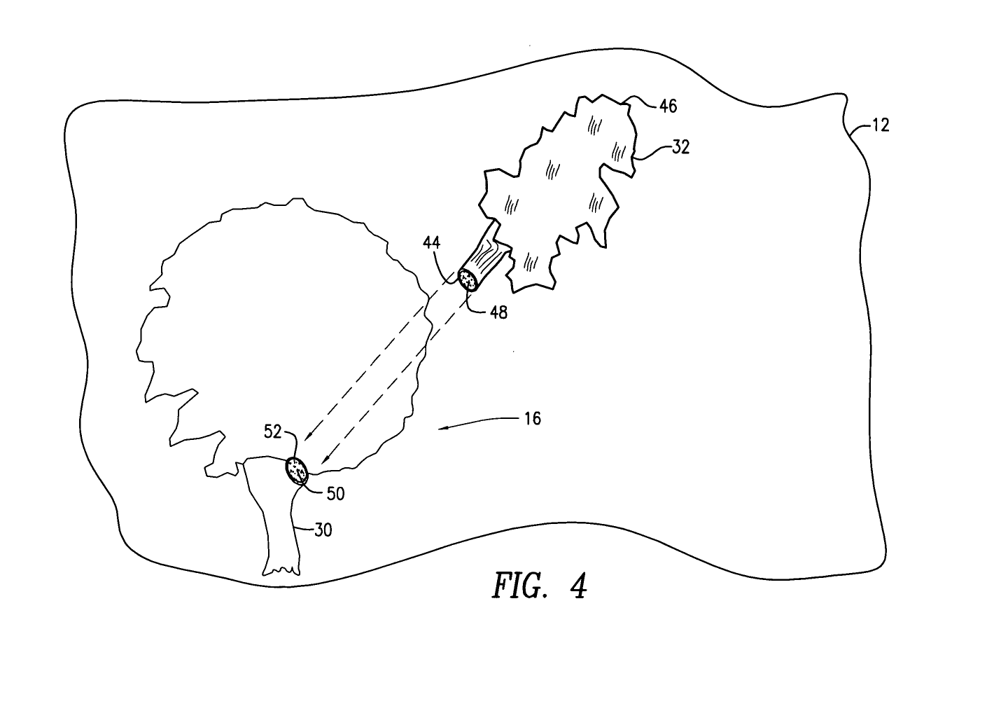

Referring to FIGS. 2 and 4, the portion 32 includes a first end 44 and a second end 46 opposite thereof. A mating element 48 is positioned at the first end 44 of the portion 32, whose function shall be described hereinafter. A corresponding mating element 50 is positioned at a predetermined location 52 of the portion 30, whose function shall be described hereinafter. The first end 44 of the portion 32 is attached to the surface 12 at the location 52 of the portion 30, while the second end 46 of the portion 32 extends outwardly from the surface 12.

It is noted that the portion 28 and the portion 32 are each, preferably, manufactured from plastic. Alternatively, the portion 28 and/or the portion 32 can be manufactured from other materials, such as STYROFOAM® brand of polystyrene foam, cardboard, paper mache, wood, plastic, metal, an inflatable plastic material, etc.

Referring to FIGS. 1 through 4, the kit 10 is utilized in the following manner. The background scenic components 18, 20, 22 and 24 are applied to the surface 12. For example, the components 18, 20, 22 and 24 can be composed of paints, stencils, markers, adhesive sheets of paper or laminates, stickers, or any other decorating apparatus known in the art. Next, the portions 14 and 16 are applied to the surface 12. The portions 14 and 16 can be composed of paints, stencils, adhesive sheets of paper or laminates, stickers or any other decorating apparatus known in the art.

The mating element 40 of the portion 26 is affixed to the surface 12 at the predetermined location 42 of the portion 26 (see FIG. 3). The mating element 40 may include, for example, a VELCRO® brand of hook and loop fastener. The first end 34 of the portion 28 is then attached to the surface 12 at the location 42 of the portion 26. More particularly, the mating element 38 of the portion 28 is attached to the corresponding mating element 40 of the portion 26. The mating element 40 may include, for example, a VELCRO® brand of hook and loop fastener. The mating element 38, 40 are sized and shaped to ensure firm attachment to one another. While the mating elements 38, 40 may include VELCRO® fasteners, they may include other connectors and fasteners known in the art, such as screws, hooks, clasps, magnets, etc.

Similarly, the mating element 50 of the portion 30 is affixed to the surface 12 at the predetermined location 52 of the portion 30 (see FIG. 4). The mating element 50 may include, for example, a VELCRO® brand of hook and loop fastener. The first end 44 of the portion 32 is then attached to the surface 12 at the location 52 of the portion 30. More particularly, the mating element 48 of the portion 32 is attached to the corresponding mating element 50 of the portion 30. The mating element 50 may include, for example, a VELCRO® brand of hook and loop fastener. The mating elements 48, 50 are sized and shaped to ensure firm attachment to each another. While the mating elements 48, 50 may include VELCRO® fasteners, they may include other connectors and fasteners known in the art, such as screws, hooks, clasps, magnets, etc.

As is apparent from the foregoing, the kit 10 may be utilized in a different manner to achieve the same end result. For example, each of the portions 14 and 16 may first be applied to the surface 12 and, thereafter, the components 18, 20, 22 and 24 may be applied to the surface 12.

As previously mentioned, the components 14 and 16 and the components 18, 20, 22 and 24 may be applied to the surface 12 at predetermined locations. Alternatively, a user can apply each of the foregoing components anywhere on the surface 12 as desired. For instance, the positions of the components 14 and 16 depicted in FIG. 1 can be interchanged with one another. Also, each of the components 18 can be positioned against the component 20 anywhere as desired. In addition, the number of components can be more or less than that depicted in FIG. 1, some components need not be utilized, or some components can be interchanged. For instance, a user can eliminate the components 18 and replace them with, for example, a depiction of a sun (not shown in the Figures). This allows a user to change the scenery on the surface 12 as desired.

It is also noted that the kit 10 may include components that relate to any desired theme (e.g., sports, holidays, seasonal, cartoon figures, astronomy, cars, etc.). In this regard, the components 14 and 16 and the components 18, 20, 22 and 24 can be sized and shaped so as to coincide with the overall theme of the kit. For example, the component 22 can be sized and shaped to depict a football stadium with a crowd of people, while the component 24 can be sized and shaped to depict a corresponding football field (not shown in the Figures). Likewise, the components 14 and 16 can be sized and shaped to depict opposing football players, while the component 28 can be sized and shaped to depict a football or a face mask (not shown in the Figures). Therefore, many variations and modifications to the scenic themes and designs can be employed with the kit 10 and is limited only by the imagination.

Also, the kit 10 may include additional components to be utilized in the room which match with the overall theme of the kit 10. In line with the aforesaid examples, the kit 10 may include bed linens, window curtains, waste baskets, lampshades, rugs, soap dishes and toothbrush holders, etc. (not shown in the Figures) that depict dinosaurs or football players. Of course, the aforesaid items can relate to any theme as governed by the kit 10 (e.g., sports, holidays, seasonal, cartoon figures, astronomy, cars, etc.).

The present invention has been adapted for use as part of the décor of a child's bedroom. However, the present invention can be utilized to decorate other rooms in a residence, such as adult bedrooms, recreational rooms, bathrooms, etc. In addition, the present invention can be utilized to decorate other environments or venues, such as hotels, theme restaurants, amusement parks, casinos, offices, etc. Also, the present invention has been adapted for use on upwardly extending walls. However, the present invention can be utilized in connection with other surfaces, such as ceilings, floors or any other structural surface.

It should be understood that the embodiments described herein are merely exemplary and that a person skilled in the art may make many variations and modifications without departing from the spirit and scope of the invention. Accordingly, all such variations and modifications are intended to be included within the scope of the invention as defined in the appended claims.

I claim:

1. A kit for decorating a surface, comprising application means for applying at least one two-dimensional scenic component to the surface; at least one three-dimensional scenic component having a first end and a second end opposite thereof; and affixation means for affixing said first end of said at least one three-dimensional scenic component to the surface, said at least one two-dimensional scenic component and said at least one three-dimensional scenic component being sized and shaped so as to depict a corresponding scene on the surface.

2. The kit as claimed in claim 1, wherein said at least one three-dimensional scenic component is positioned at a predetermined location on the surface.

3. The kit as claimed in claim 2, wherein said predetermined location is juxtaposed with said at least one two-dimensional scenic component.

4. The kit as claimed in claim 2, wherein said predetermined location is positioned on said at least one two-dimensional scenic component.

5. The kit as claimed in claim 1, wherein said first application means includes a paint set.

6. The kit as claimed in claim 1, wherein said first application means includes a stencil set.

7. The kit as claimed in claim 1, wherein said first application means includes at least one adhesive laminate.

8. The kit as claimed in claim 8, wherein said affixation means includes an adhesive.

9. The kit as claimed in claim 2, wherein said affixation means includes a first connector on said first end of said at least one three-dimensional scenic component, and a second connector on the surface.

10. The kit as claimed in claim 9, wherein said second connector is positioned at said predetermined location.

11. The kit as claimed in claim 10, wherein said first connector includes at least one screw and said second connector includes a corresponding at least one screw anchor.

12. The kit as claimed in claim 11, wherein said first connector includes at least one hook and loop fastener and said second connector includes a corresponding at least one hook and loop fastener.

13. The kit as claimed in claim 11, wherein said first connector includes at least one hook and said second connector includes a corresponding at least one eyehook.

14. The kit as claimed in claim 1, wherein said at least one two-dimensional scenic component includes a plurality of two-dimensional scenic components.

15. The kit as claimed in claim 14, wherein said at least one three-dimensional scenic component includes a plurality of three-dimensional scenic components.

16. The kit as claimed in claim 15, wherein one of said plurality of three-dimensional scenic components is positioned on a corresponding one of said plurality of two-dimensional scenic components.

17. The kit as claimed in claim 1, wherein said at least one three-dimensional scenic component is made from polystyrene foam.

18. The kit as claimed in claim 1, wherein said at least one three-dimensional scenic component is made from plastic.

19. The kit as claimed in claim 18, wherein said at least one three-dimensional scenic component is made from an inflatable plastic material.

20. The kit as claimed in claim 1, wherein said at least one three-dimensional scenic component is made from wood.
